(19) United States
(12) Patent Application Publication
(10) Pub. No.: US 2003/0115092 A1
(43) Pub. Date: Jun. 19, 2003

(54) Worksite smoking policy audit system

(76) Inventors: Paul Barnett, Weybridge (GB); John Griffiths, Cardiff (GB); Caroline Howe, London (GB); Charlotte Lewis, London (GB); Mark Vince, Middlesex (GB)

Correspondence Address: GLAXOSMITHKLINE, Corporate Intellectual Property-UW2220, P.O. Box 1539, King of Prussia, PA, 19406-0939, US

(21) Appl. No.: 10/279,540

(22) Filed: Oct. 24, 2002

Related U.S. Application Data
(60) Provisional application No. 60/336,388, filed on Oct. 25, 2001.

(51) Int. Cl. G06F 17/60

(52) U.S. Cl. 705/10

(57) ABSTRACT

The invention relates to a smoking policy audit system and method for a plurality of users. A computer system is generally operable to service user requests and provide users with information responsive to the user requests. The computer system is coupled to a smoking policy audit database. The database is operable to a store plurality of questions associated with a smoking policy audit, smoking policy recommendations and smoking policy comments. The computer system is operable to present the user with a question from the smoking policy audit database and receive an answer from the user in response to the question. The computer system is also operable to generate at least one report including the smoking policy recommendations and smoking policy comments that correlate with the user's answers.

This application claims the benefit of U.S. Provisional Application No. 60/336,388, filed Oct. 25, 2001.

The present invention relates generally to the field of computerized audit systems and more particularly to a worksite smoking policy audit system. The invention generally includes an on-line questionnaire that is completed by the employer in light of their existing smoking policy for one or more worksites. The audit system then generates a report (including a series of tailored responses) based on the supplied answers. The report enables the employer to make improvements to their worksite smoking policy or if they have no smoking policy provides guidance in how to set one up from scratch.

The worksite smoking policy audit system includes a user interface for providing user access to a smoking policy audit database. In one embodiment, the company representative or user logs onto the system via a typical Internet Web Browser and is presented with a plurality of web pages. The system preferably queries the user whether they are a new user or an existing user. New users are preferably required to register with the system (e.g., provide contact infromation, select user name and password and the like). Existing users log into the system using a previously selected username and password.

The user is then presented a web based questionnaire that assesses the company's existing no-smoking policy. The questionnaire is preferably divided into 5 sections, which the user completes sequentially. The system takes the user's answers or responses and correlates these with various information in the smoking policy audit database. Once the user completes a section, the system is operable to generate a report with various recommendations and comments on an existing or proposed smoking policy. The system preferably provides background information on each section or a list of the questions upon user request.

### SUMMARY OF THE INVENTION

The invention is directed to a smoking policy audit system and method for a plurality of users. The system includes a computer system operable to service user requests and provide users with information responsive to the user requests. A smoking policy audit database is coupled to the computer system. The database is operable to a store plurality of questions associated with a smoking policy audit. The database also stores smoking policy recommendations and smoking policy comments. The system is preferably operable to present the user with a question from the smoking policy audit database and receive an answer from the user in response to the question. The term “present” is used herein in its broadest sense and encompasses the transmission of data for actual display by another device—such as a web browser.

The system is also preferably operable to correlate the user's answer to at least one question with at least one smoking policy recommendation and smoking policy comment stored in the smoking policy audit database. Optionally, the system is operable to correlate a user's answer to a plurality of questions with at least one smoking policy recommendation and smoking policy comment stored in the smoking policy audit database.

The plurality of questions (e.g., questionnaire) can optionally be divided into a plurality of sections. In one embodiments, the plurality of questions are divided into five sections directed to background information, existing smoking policies, employee involvement, canvassing opinion and support and smoking cessation.

The computer system is preferably operable to generate at least one report including at least one smoking policy recommendation and smoking policy comment that correlate with the user's answer to at least one question.

### BRIEF DESCRIPTION OF THE DRAWINGS

FIG. 1 shows a general block diagram of a system in accordance with the invention.

FIG. 2 shows an exemplary login page in accordance with the invention;

FIG. 3 shows an exemplary user registration page in accordance with the invention;

FIG. 4 shows an exemplary summary page in accordance with the invention;

FIG. 5 shows an exemplary question page is accordance with the invention;

FIG. 6 shows an updated summary page in accordance with the invention; and

FIG. 7 shows a portion of an exemplary report in accordance with the invention.

### DETAILED DESCRIPTION OF THE INVENTION

The invention provides an automated worksite smoking policy audit system that provides information and advice via an on-line audit system. Users are generally provided with recommendations on how to implement and/or improve a smoking policy and introduce training around smoking cessation.

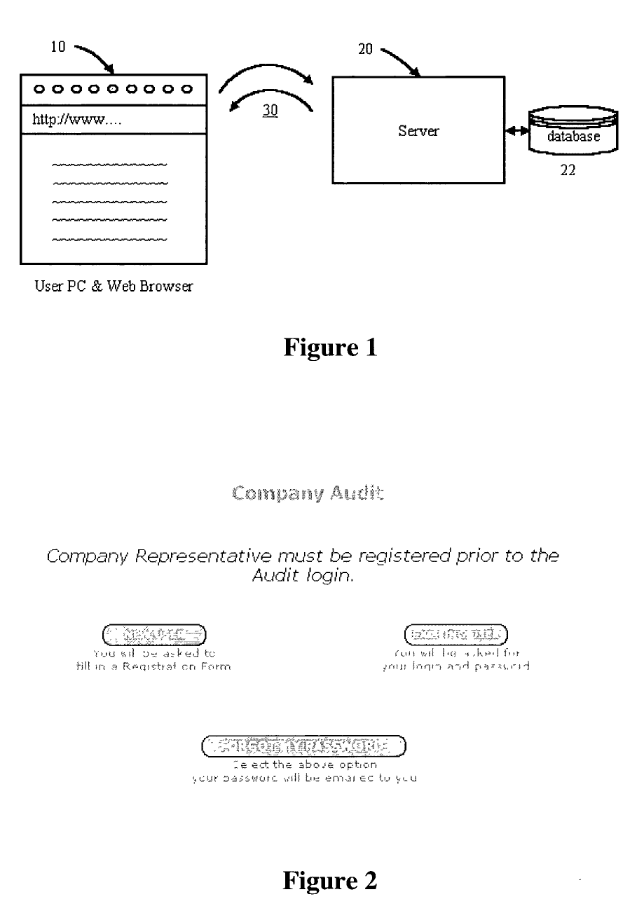

FIG. 1 shows a general block diagram of a system in accordance with the invention. The worksite smoking policy audit system includes a user interface for providing user access to a smoking policy audit database. The term “database” generally refers to a collection of information stored for later retrieval. The term “database” is used herein in its broadest sense (i.e., a collection of information) and is not limited to any particular structure or implementation.

In a preferred embodiment, the company logs onto the program via a typical Internet Web Browser 10 and is presented with a plurality of web pages. The user accesses the system via a network processing device and web browser (e.g., PC, PDA and the like). The user is then presented with a login screen, which prompts for a user name and password. The system includes at least one server 20 (e.g., WWW server) operable to receive data from a user and provide data or content in response to user input. The system also includes a smoking policy audit database 22 as described in more detail below. Data communications paths between the user PC and Web Browser 10 and the server 20 are shown generally by arrows 30. It is understood that data communications via the Internet often traverse a series of intermediate network nodes prior to reaching the desired destination (e.g., the user PC and Web Browser or the content provider Web site). Arrows 30 do not suggest a direct physical connection between the user PC and Web Browser 10 and/or various servers and encompass typical Internet communications (a connectionless, best-efforts packet-based system). It is also understood that a variety of data networks using various network protocols are suitable for use in accordance with the invention.

The user PC and Web Browser 10 is operable to accesses the Internet World Wide Web (WWW or Web). The user PC is preferably has an associated operating system such as Microsoft Windows or Linux and includes a typical Web Browser such as Netscape Communicator (for Windows or Linux) or Microsoft Internet Explorer, as well as numerous others. The Web Browser assists the user in requesting and displaying Web pages or sites containing desired information. The hardware and software configuration of a user network processing device for Internet access is routine and generally known to those skilled in the art.

The server 20 preferably includes an HTTP server for use in connection with an Internet Web site. There are many varieties of commercially or publicly available Web server software packages that are compatible with the invention, all of which can be implemented with commonly available hardware. The implementation of a suitable server and database system for use in connection with the invention, in accordance with the disclosure herein, is well within the grasp of those skilled in the art.

FIG. 2 shows an exemplary login page in accordance with the invention. The system preferably queries the user whether they are a new user or an existing user. For existing users, the system receives the user name and password and compares them to previously stored values. Assuming the user name and password are valid, the user is permitted to access the system. If the user has forgotten their password, the system preferably provides a mechanism for granting access to the system (e.g., a security question must be answered correctly before access is granted).

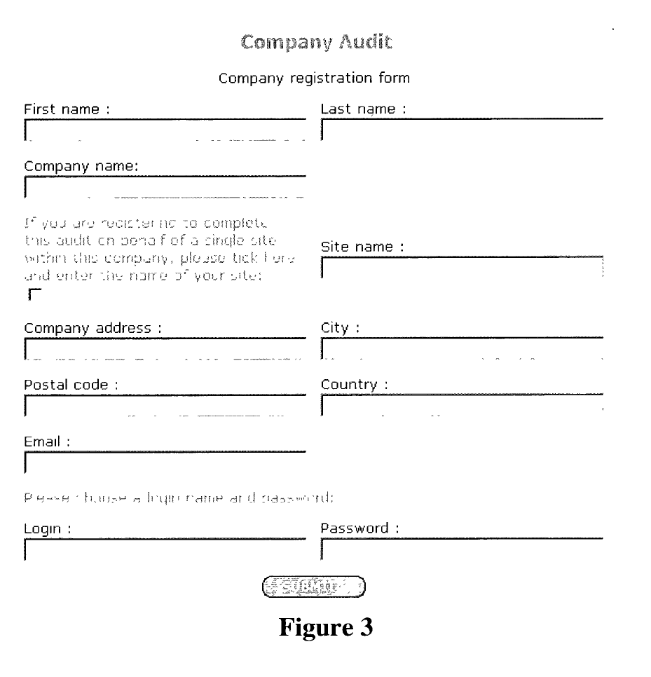

New users are preferably required to register with the system (e.g., provide contact infromation, select user name and password and the like). FIG. 3 shows an exemplary user registration page in accordance with the invention. It is understood that user related information can be encrypted or otherwise protected to prevent unauthorized individuals from capturing any sensitive information. The implementation and administration of a user registration system is well known in the art.

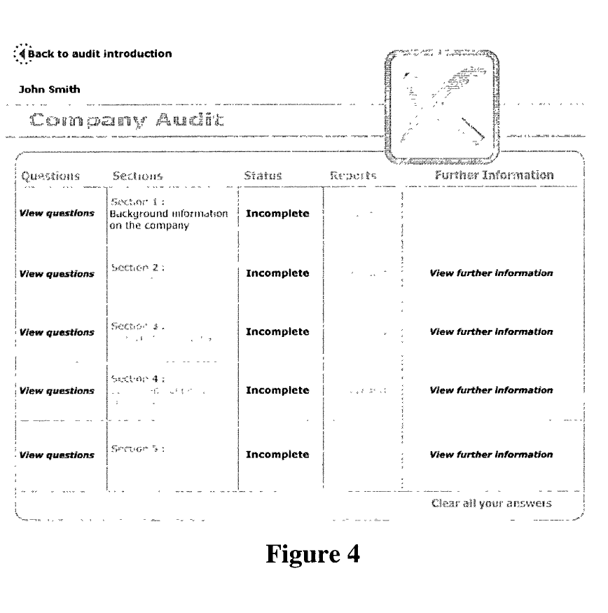

After logging in, the user is then preferably presented with a summary screen identifying the user (e.g., John Smith), that status of the various sections that they have completed and the like. FIG. 4 shows an exemplary summary page in accordance with the invention. The user can then proceed with the individual sections of the questionnaire and assess the company's no-smoking policy.

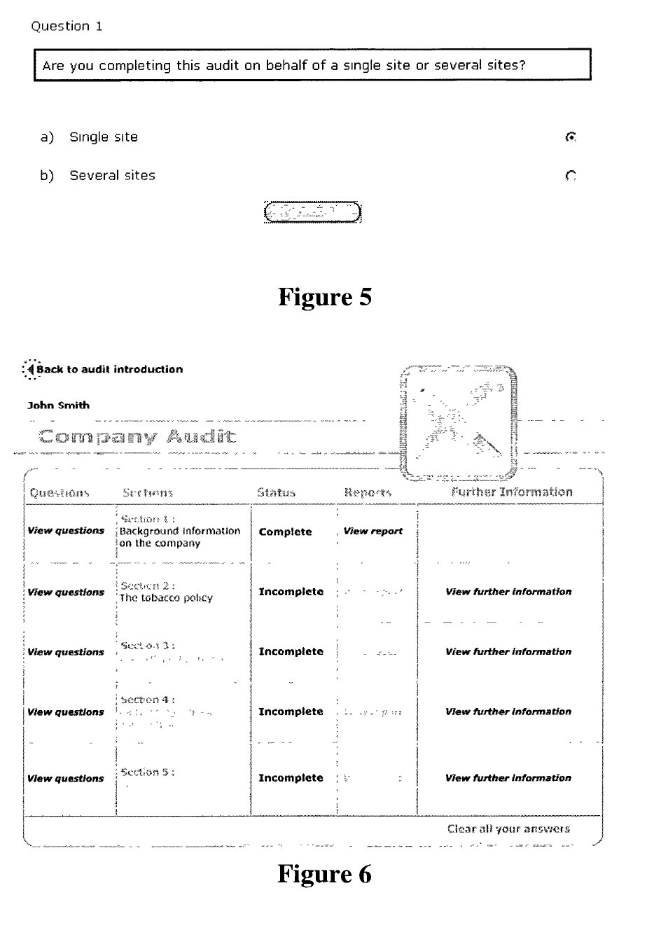

The questionnaire is preferably divided into 5 sections, which the user completes sequentially. FIG. 5 shows an exemplary question page is accordance with the invention. In general, the user is presented with a question and two or more potential answers or responses, each potential response is associated with a check box. The user selects the appropriate response by clicking on the appropriate check box and then clicks on accept. The system at least temporarily records the user's response and then presents the user with the next question in the section. Once the section is complete, the user is preferably presented with an updated summary page showing that the section has been completed.

The user is then preferably presented with an option to review the report for the completed section. The report is automatically generated with various comments and recommendations based on the users responses. The logic used to correlate particular user responses with information in the database is discussed in more detail below. The user can view the report by clicking on the “View report” link. Optionally, the user can view background information on each section or the actual audit questions by clicking on “View background information” or “View questions” links respectively. See FIG. 4.

Audit Section 1—Background Information

As discussed above, the audit questionnaire is preferably broken down into a plurality of sections (e.g., 5 sections). An exemplary audit section 1 is discussed below. In this example, audit section 1 requests background information from the user. A complete listing of audit questions appears in Appendix A. The comments and recommendations contained in the smoking policy audit database for this section are shown in Appendix B. For matters of completeness, these questions are also discussed in more detail below. Section 1 includes questions tailored to identify the size and type of business at issue.

Each of the questions in audit section 1 are associated with two or more potential answers or responses. When presented with the question in section 1, the user selects a single answer as their response. FIG. 5 shows an exemplary question page is accordance with the invention. In the example, question 1 is as follows:

1. Are you completing this audit on behalf of a single site or several sites?

a) Single site

b) Several sites

The user selects the appropriate selects the appropriate response by clicking on the appropriate check box and then clicks on accept. The system at least temporarily records the user's response and ultimately correlates the response with information in the smoking policy audit database. Table 1 below shows exemplary smoking policy audit database content that is associated with the each potential user response. Selection of response “a” correlates to the first row in the table and a score of 1. Selection of response “b” correlates to the second row in the table and a score of 2, etc. etc. The system is optionally operable to tabulate all of the scores for each question in each section and associate and calculate an overall score for the individual section and/or the entire audit.

TABLE 1

| Q | Score | Comment | Recommendations |
|---|---|---|---|
| 1 | 1 | As your organization is based on | Seek to inform and involve |
| | | a single site you should find | employees about the |
| | | addressing the issue of tobacco | activities that are being |
| | | in the workplace to be | developed to address the |
| | | straightforward. However the | issue of smoking at work |
| | | issue can be contentious and the | whenever possible. |
| | | views and perceptions of the | |
| | | employees will need to be taken | |
| | | into account. For the process to | |
| | | be successful it is important to | |
| | | provide employees with good | |
| | | quality information about the | |
| | | measures being adopted and | |
| | | provide them with the | |
| | | opportunity to respond with | |
| | | comments, suggestions and | |
| | | questions. | |
| | 2 | Addressing the issue of smoking | Seek to inform and involve |
| | | at work is a positive and | employees about the |
| | | constructive thing to do. It can | activities that are being |
| | | also be a straightforward process | developed to address the |
| | | to implement. The way in which | issue of smoking tobacco |
| | | the process is established is | in the workplace whenever |
| | | important and has a significant | possible and pay particular |
| | | impact on the long-term | attention to the issue of |
| | | sustainability of the approach | communication within and |
| | | being adopted. Of particular | between sites. You may |
| | | importance is the need to | find it helpful to establish |
| | | involve employees in the process | an organization wide |
| | | at an early stage, and then | steering group to give |
| | | maintain their involvement. As | direction to the process and |
| | | an organization which is based | to supplement this with |
| | | on more than one site you | working groups on each |
| | | should try to ensure that | site. |
| | | employees in all the sites are | |
| | | provided with good quality | |
| | | information about the measures | |
| | | being adopted and are also given | |
| | | the opportunity to respond with | |
| | | comments, suggestions and | |
| | | questions. | |

Continuing with this example, question 2 is as follows:

2. How many employees are currently working for your organization?

a) <100

b) 100- 249

c) 249- 499

d) >500

Again, the user selects the appropriate selects the appropriate response by clicking on the appropriate check box and then clicks on accept. The system at least temporarily records the users response and ultimately correlates the response with information in the smoking policy audit database. Table 2 below shows exemplary smoking policy audit database content that is associated with the possible user responses for this question.

TABLE 2

| Q | Score | Comment | Recommendations |
|---|---|---|---|
| 2 | 1 | Your organization has the opportunity | Complete the |
| | | to tackle tobacco in the workplace in a | remainder of this |
| | | constructive and positive manner. With | audit, ideally |
| | | fewer than 100 employees, most, if not | involving one or |
| | | all of them are likely to know each | two of your key |
| | | other by name, and smoking behavior | colleagues such as |
| | | will probably be well known. Smoking | the health and safety |
| | | in the workplace is an issue that can | representative and |
| | | arouse strong feelings, and it needs to | an employee |
| | | be addressed in a sensitive way. | representative. |
| | | Completing this audit will provide you | |
| | | with guidance on the response that your | |
| | | organization might wish to take to | |
| | | address tobacco use in the workplace. | |
| | | Addressing the issue of smoking | |
| | | should not be viewed as yet another | |
| | | burden. By acting now, you will be | |
| | | establishing good practice, enhancing | |
| | | the working conditions of your | |
| | | employees and improving the | |
| | | productivity of your organization. | |
| | 2 | Your organization has the opportunity | Complete the |
| | | to tackle tobacco in the workplace in a | remainder of this |
| | | constructive and positive manner. With | audit, ideally with |
| | | fewer than 250 employees, most, if not | colleagues from the |
| | | all of them will know each other by | occupational health |
| | | name, and smoking behavior will | department or |
| | | probably be well known. However, | occupational health |
| | | smoking in the workplace is an issue | provider, the |
| | | that can arouse strong feelings and | human resources |
| | | needs to be addressed in a sensitive | department, a |
| | | way. Completing this audit will provide | health and safety |
| | | you with guidance on the nature and | representative and |
| | | types of response that your | an employee |
| | | organization might wish to take to | representative. |
| | | address tobacco use in the workplace. | |
| | | Addressing the issue of smoking | |
| | | should not be viewed as yet another | |
| | | burden. By acting now, you will be | |
| | | establishing good practice, enhancing | |
| | | the working conditions of your | |
| | | employees and improving the | |
| | | productivity of your organization. | |
| | 3 | Your organization has the opportunity | Complete the |
| | | to tackle tobacco in the workplace in a | remainder of this |
| | | constructive and positive manner. Your | audit, ideally with |
| | | organization is relatively large, and will | colleagues from the |
| | | almost certainly have a well-defined | occupational health |
| | | HR function, health and safety | department or |
| | | representatives, some form of | occupational health |
| | | occupational health service, and | provider, the |
| | | mechanisms to consult with staff. | human resources |
| | | Smoking in the workplace is an issue | department, a |
| | | that can arouse strong feelings and | health and safety |
| | | needs to be addressed in a sensitive | representative and |
| | | manner. Your organization should seek | an employee |
| | | to create a small team (probably drawn | representative. |
| | | from the groups listed above) to take | |
| | | the issue forward. Completing this | |
| | | audit will provide you with guidance | |
| | | on the nature and types of response that | |
| | | your organization might wish to take to | |
| | | address tobacco use in the workplace. | |
| | | Addressing the issue of smoking | |
| | | should not be viewed as yet another | |
| | | burden. By acting now, you will be | |
| | | establishing good practice, enhancing | |
| | | the working conditions of your | |
| | | employees and improving the | |
| | | productivity of your organization. | |
| | 4 | Your organization has the opportunity | Complete the |
| | | to tackle tobacco in the workplace in a | remainder of this |
| | | constructive and positive manner. As a | audit, ideally with |
| | | large company, your organization will | colleagues from the |
| | | almost certainly have a well-defined | occupational health |
| | | HR function, health and safety | department or |
| | | representatives, some form of | occupational health |
| | | occupational health service, and | provider, the |
| | | mechanisms to consult with staff. | human resources |
| | | Smoking in the workplace is an issue | department, a |
| | | that can arouse strong feelings and | health and safety |
| | | which needs to be addressed in a | representative and |
| | | sensitive manner. Your organization | an employee |
| | | should seek to create a small team | representative. |
| | | (probably drawn from the groups listed | |
| | | above) to take the issue forward. | |
| | | Completing this audit will provide you | |
| | | with guidance on the response that your | |
| | | organization might wish to take to | |
| | | address tobacco use in the workplace. | |
| | | Addressing the issue of smoking | |
| | | should not be viewed as yet another | |
| | | burden. By acting now, you will be | |
| | | establishing good practice, enhancing | |
| | | the working conditions of your | |
| | | employees and improving the | |
| | | productivity of your organization. | |

Continuing with this example, question 3 is as follows:

3. Which business sector best describes your organization?

a) Public

b) Private

c) Voluntary organization

d) Non-governmental organization (NGO)

Again, the user selects the appropriate selects the appropriate response by clicking on the appropriate check box and then clicks on accept. The system at least temporarily records the users response and ultimately correlates the response with information in the smoking policy audit database. Table 3 below shows exemplary smoking policy audit database content that is associated with the possible user responses for this question.

TABLE 3

| Q | Score | Comment | Recommendations |
|---|---|---|---|
| 3 | 1 | It is important that all organizations | Use the completion |
| | | address the issue of smoking at work. | of this audit as an |
| | | As a public sector organization you | opportunity to |
| | | have the opportunity to act as a model | review your |
| | | for other organizations in your area, and | organization's |
| | | your contact with the general public | attitude towards |
| | | means that the scope of the measured | smoking at work, |
| | | you introduce could have a far-reaching | existing measures to |
| | | effect. | control it and also as |
| | | Experience indicates that passive | a tool to help you |
| | | smoking should be incorporated into | review and refine |
| | | any workplace risk assessments that you | these measures and |
| | | may undertake and that measures to | where appropriate |
| | | control all risks to the health and | plan new |
| | | well-being of employees should be put | approaches. |
| | | in place. | |
| | | Being seen to care for the health and | |
| | | well-being of employees is widely | |
| | | recognized as a sign of a good employer | |
| | | and this helps with both the recruitment | |
| | | and the retention of staff. Therefore | |
| | | acting positively but sensitively on the | |
| | | issue of smoking in the workplace will | |
| | | send a positive message to your | |
| | | employees and the wider community. | |
| | 2 | It is important that all organizations | Use the completion |
| | | address the issue of smoking at work. | of this audit as |
| | | As an organization involved in | an opportunity |
| | | manufacturing you will be only too well | to review your |
| | | aware of the need to provide a safe | organization's |
| | | working environment for your | attitude towards |
| | | employees. Experience indicates that | smoking at work, |
| | | tobacco smoke should be incorporated | existing measures to |
| | | into any workplace risk assessments that | control it and also |
| | | you may undertake and that measures to | as a tool to help you |
| | | control all risks to the health and | review and refine |
| | | well-being of employees should be put | these measures and |
| | | in place. | where appropriate |
| | | Being seen to care for the health and | plan new |
| | | well-being of employees is widely | approaches. |
| | | recognized as a sign of a good employer | |
| | | and this helps with both the recruitment | |
| | | and retention of staff. Therefore acting | |
| | | positively but sensitively on the issue of | |
| | | smoking in the workplace will send a | |
| | | strong message to your employees and | |
| | | the wider community. | |
| | 3 | It is important that all organizations | Use the completion |
| | | address the issue of smoking at work. | of this audit as |
| | | As a service based organization you will | an opportunity |
| | | be only too well-aware of the need to | to review your |
| | | provide a safe working environment for | organization's |
| | | your employees. Experience indicates | attitude towards |
| | | that tobacco smoke should be | smoking at work, |
| | | incorporated into any workplace risk | existing measures to |
| | | assessments that you may undertake and | control it and also |
| | | that measures to control all risks to | as a tool to help you |
| | | the health and well-being of employees | review and refine |
| | | should be put in place. | these measures and |
| | | Being seen to care for the health and | where appropriate |
| | | well-being of employees is widely | plan new |
| | | recognized as a sign of a good employer | approaches. |
| | | and this helps with both the recruitment | |
| | | and retention of staff. Therefore acting | |
| | | positively but sensitively on the issue | |
| | | of smoking in the workplace will send a | |
| | | strong message to your employees and | |
| | | the wider community. | |
| | 4 | As a voluntary sector organization you | Use the completion |
| | | will be addressing very real needs, | of this audit as |
| | | often in challenging and difficult | an opportunity |
| | | circumstances. Your employees will be | to review your |
| | | a key resource for both the organization | organization's |
| | | and the needs it addresses. Protecting | attitude towards |
| | | your employees health and well-being is | smoking at work, |
| | | clearly a key task for the organization. | existing measures to |
| | | It is important that the issue of | control it and also |
| | | smoking at work is addressed by all | as a tool to help you |
| | | organizations for being seen to care for | review and refine |
| | | the health and well-being of employees | these measures and |
| | | is widely recognized as a sign of a good | where appropriate |
| | | employer and this helps with both the | plan new |
| | | recruitment and retention of staff. | approaches. |
| | | Therefore acting positively but | |
| | | sensitively on the issue of smoking in | |
| | | the workplace will send a strong | |
| | | message to your employees and to the | |
| | | wider community | |
| | 5 | As an NGO your organization will have | Use the completion |
| | | many demands placed upon it. Your | of this audit as an |
| | | employees are your key resource and | opportunity to |
| | | protecting their health and well-being is | review your |
| | | clearly a key task for the organization. | organization's |
| | | It is important that all organizations | attitude towards |
| | | address the issue of smoking at work. | smoking at work, |
| | | Being seen to care for the health and | existing measures |
| | | well-being of employees is widely | to control it and |
| | | recognized as a sign of a good employer | also as a tool to |
| | | and this helps with both the recruitment | help you review |
| | | and retention of staff. Therefore acting | and refine these |
| | | positively but sensitively on the issue | measures and where |
| | | of smoking in the workplace will send a | appropriate plan |
| | | strong message to your employees and | new approaches. |
| | | to the wider community. | |

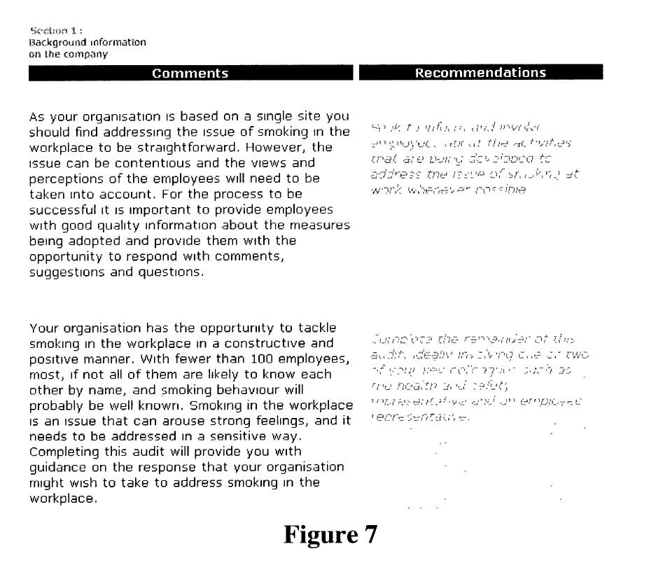

In this example, audit section 1 contains three questions. Upon submission of a response to the last question in the section, the user is preferably presented with an updated summary page. FIG. 6 shows an updated summary page in accordance with the invention. The user is then presented with the option of viewing the report. As discussed above, the report is compiled using a portion of the information contained in the smoking policy audit database. The particular information in the report is selected based on the user responses that are received by the system. FIG. 7 shows a portion of an exemplary report in accordance with the invention. As discussed above, the report contains a portion of information or data from the smoking policy audit database. The data is selected based on the user's responses to the audit questions contained in the section at issue.

Audit Section 2—The Smoking Policy

An exemplary audit section 2 is discussed below. In this example, audit section 2 requests information relating to any existing smoking policies. A complete listing of audit questions appears in Appendix A. The comments and recommendations contained in the smoking policy audit database for this section are shown in Appendix C.

As discussed in the previous section, the user selects the appropriate response for each audit question by clicking on the appropriate check box and then clicks on accept. The system at least temporarily records the user's responses and ultimately correlates the responses with information in the smoking policy audit database. Upon submission of a response to the last question in the section, the user is preferably presented with an updated summary page. The user is then presented with the option of viewing the report. As discussed above, the report is compiled using a portion of the data or information contained in the smoking policy audit database. The particular information in the report is selected based on the user responses that are received by the system as detailed in Appendix C.

Audit Section 3—Employee Involvement

An exemplary audit section 3 is discussed below. In this example, audit section 3 requests information relating to the level of employee involvement. A complete listing of audit questions appears in Appendix A. The comments and recommendations contained in the smoking policy audit database for this section are shown in Appendix D.

Some of the questions in section 3 allow the user to select multiple responses by clicking on one or more check boxes and then clicking on accept. The system at least temporarily records the user's responses and ultimately correlates the responses with information in the smoking policy audit database. Upon submission of a response to the last question in the section, the user is preferably presented with an updated summary page. The user is then presented with the option of viewing the report. As discussed above, the report is compiled using a portion of the information contained in the smoking policy audit database. The particular information in the report is selected based on the user responses that are received by the system as detailed in Appendix D.

Audit Section 4—Canvassing Opinion and Support

An exemplary audit section 4 is discussed below. In this example, audit section 4 requests information relating to canvassing opinion and support. A complete listing of audit questions appears in Appendix A. The comments and recommendations contained in the smoking policy audit database for this section are shown in Appendix E.

The relationship between the user's responses and the associated comments and recommendation are more complex for this section. For example, the question pool for section 4 is preferably sub-divided into a plurality of groups. Within each group, the logic is varied in order to determine which comments and recommendation are included in the report. Some of the questions may allow the selection of two or more answers. The answers to two or more questions within a group can also be utilized to determine which comments and recommendation are ultimately included in the report.

The system at least temporarily records the user's response and ultimately correlates the response with information in the smoking policy audit database. Upon submission of a response to the last question in the section, the user is preferably presented with an updated summary page. The user is then presented with the option of viewing the report. As discussed above, the report is compiled using a portion of the information or data contained in the smoking policy audit database. The particular information in the report is selected based on the user responses that are received by the system as detailed in Appendix E.

Audit Section 5—Smoking Cessation

An exemplary audit section 4 is discussed below. In this example, audit section 4 requests information relating to smoking cessation. A complete listing of audit questions appears in Appendix A. The comments and recommendations contained in the smoking policy audit database for this section are shown in Appendix E.

The relationship between the user's responses and the associated comments and recommendation are straight forward in this section. The system at least temporarily records the user's response and ultimately correlates the response with information in the smoking policy audit database. Upon submission of a response to the last question in the section, the user is preferably presented with an updated summary page. The user is then presented with the option of viewing the report. As discussed above, the report is compiled using a portion of the data or information contained in the smoking policy audit database. The particular information in the report is selected based on the user responses that are received by the system as detailed in Appendix F.

While this invention has been described with an emphasis upon preferred embodiments, it will be obvious to those of ordinary skill in the art that variations in the preferred devices and methods may be used and that it is intended that the invention may be practiced otherwise than as specifically described herein.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A smoking policy audit system for a plurality of users comprising:
a computer system operable to service user requests and provide users with information responsive to the user requests, and
a smoking policy audit database coupled to the computer system, wherein the database is operable to a store plurality of questions associated with a smoking policy audit, smoking policy recommendations and smoking policy comments.

2. The system of claim 1 wherein the computer system is operable to present the user with a question from the smoking policy audit database and receive an answer from the user in response to the question.

3. The system of claim 2 wherein the computer system is operable to correlate the user's answer to at least one question with at least one smoking policy recommendation and smoking policy comment stored in the smoking policy audit database.

4. The system of claim 2 wherein the computer system is operable to correlate a user's answer to a plurality of questions with at least one smoking policy recommendation and smoking policy comment stored in the smoking policy audit database.

5. The system of claim 1 wherein the plurality of questions are divided into a plurality of sections.

6. The system of claim 1 wherein the plurality of questions are divided into five sections directed to background information, existing smoking policies, employee involvement, canvassing opinion and support and smoking cessation.

7. The system of claim 3 wherein the computer system is operable to generate at least one report including at least one smoking policy recommendation and smoking policy comment that correlate with the user's answer to at least one question.

8. A smoking policy audit method for a plurality of users comprising:
providing a computer system operable to service user requests and provide users with information responsive to the user requests, and
providing a smoking policy audit database coupled to the computer system, wherein the database is operable to a store plurality of questions associated with a smoking policy audit, smoking policy recommendations and smoking policy comments.

9. The method of claim 8 wherein the computer system is operable to present the user with a question from the smoking policy audit database and receive an answer from the user in response to the question.

10. The method of claim 9 wherein the computer system is operable to correlate the user's answer to at least one question with at least one smoking policy recommendation and smoking policy comment stored in the smoking policy audit database.

11. The method of claim 9 wherein the computer system is operable to correlate a user's answer to a plurality of questions with at least one smoking policy recommendation and smoking policy comment stored in the smoking policy audit database.

12. The method of claim 8 wherein the plurality of questions are divided into a plurality of sections.

13. The method of claim 8 wherein the plurality of questions are divided into five sections directed to background information, existing smoking policies, employee involvement, canvassing opinion and support and smoking cessation.

14. The method of claim 10 wherein the computer system is operable to generate at least one report including at least one smoking policy recommendation and smoking policy comment that correlate with the user's answer to at least one question.
